(19) United States
(12) Patent Application Publication
(10) Pub. No.: US 2015/0254942 A1
(43) Pub. Date: Sep. 10, 2015

(54) QR CODE RECEIPT

(71) Applicant: Diebold Self-Service Systems division of Diebold, Incorporated, North Canton, OH (US)

(72) Inventor: Mukund AGARAWAL, Mumbai (IN)

(21) Appl. No.: 14/324,659

(22) Filed: Jul. 7, 2014

(30) Foreign Application Priority Data
Mar. 10, 2014 (IN) 666/DEL/2014

(51) Int. Cl. G07G 5/00; G06K 19/06

(52) U.S. Cl. CPC G07G 5/00; G06K 19/06112

(57) ABSTRACT

In an example embodiment, after a transaction, a Quick Response (“QR”) code having data representative of the transaction (e.g., a receipt) is displayed on a user interface of a device involved in the performance of the transaction. The QR code can be scanned, for example by a mobile device such as a mobile telephone, which can generate a receipt for the transaction (or transactions) based on the QR code.

### TECHNICAL FIELD

The present disclosure relates generally to transactions receipts.

### BACKGROUND

Automated banking machines, such as automated teller machines (“ATMs”) may be employed by a user to perform financial transactions with an account associated with a financial institution. Transactions carried out using ATMs may include the dispensing of cash, the making of deposits, the transfer of funds between accounts and account balance inquiries.

A point of sale (“POS”) device may be employed by a merchant to allow customers to purchase goods and/or services. For example, a POS device can accept payment from a consumer in the form of cash, check, and/or credit card.

### BRIEF DESCRIPTION OF THE DRAWINGS

The accompanying drawings incorporated herein and forming a part of the specification illustrate the example embodiments.

FIG. 1 is a block diagram illustrating an example of a Quick Response (QR) code being employed as a transaction receipt.

FIG. 2 is a block diagram illustrating an example of the QR code being translated into a receipt and subsequent forwarding.

FIG. 3 is a functional block diagram illustrating an example of an automated banking machine that provides a QR code for a transaction receipt.

FIG. 4 is a functional block diagram illustrating an example of a point of sale device that provides a QR code for a transaction receipt.

FIG. 5 is a block diagram illustrating an example of a computer system that can provide a QR code for a transaction receipt and/or create a receipt from a QR code.

FIG. 6 is a block diagram illustrating an example of a computer system coupled with a network that can provide a QR code for a transaction receipt.

FIG. 7 is a block diagram illustrating an example of a computer system that can obtain a QR code for a transaction receipt.

FIG. 8 is a block diagram illustrating a methodology that creates a QR code for a transaction receipt.

FIG. 9 is a block diagram illustrating a methodology that reads a QR code and creates a transaction receipt from the QR code.

FIG. 10 is a block diagram illustrating a methodology that provides a QR code as a transaction receipt and creates a transaction receipt from the QR code.

### OVERVIEW OF EXAMPLE EMBODIMENTS

The following presents a simplified overview of the example embodiments in order to provide a basic understanding of some aspects of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented later.

In accordance with an example embodiment, there is disclosed herein logic encoded in a tangible, non-transitory computer readable medium for execution, and when executed operable to obtain data representative of a transaction. The logic is further operable to generate a quick response (QR) code, the QR code comprises the data representative of the transaction, and to display the QR code.

In accordance with an example embodiment, there is disclosed herein, an apparatus comprising a user interface module that comprises a display and an input device, a printer, and a processor coupled with the user interface module, and the printer. The processor is operable to perform transactions based on data obtained from users via the user interface module. The processor is operable to output an option for users to request a printed receipt or a quick response (QR) code receipt for a transaction. The processor is operable to obtain an input from a user via the input device indicating a selection of either a printed receipt or a QR receipt. The processor is operable to selectively print a receipt for a transaction to a user requesting a printed receipt. The processor is operable to selectively display a on the display for a transaction to a user requesting a QR code receipt.

In accordance with an example embodiment, there is disclosed herein logic encoded in a tangible, non-transitory computer readable medium for execution, and when executed operable to obtain a quick response (QR) code that comprises data representative of a transaction. The logic is further operable to create a receipt for the transaction from the QR code.

In accordance with an example embodiment, there is disclosed herein, an apparatus comprising a scanner and a processor coupled with the scanner. The scanner is operable to obtain a quick response (QR) code that comprises data representative of a transaction. The processor is operable to create a receipt for the transaction from the QR code.

### Description of Example Embodiments

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

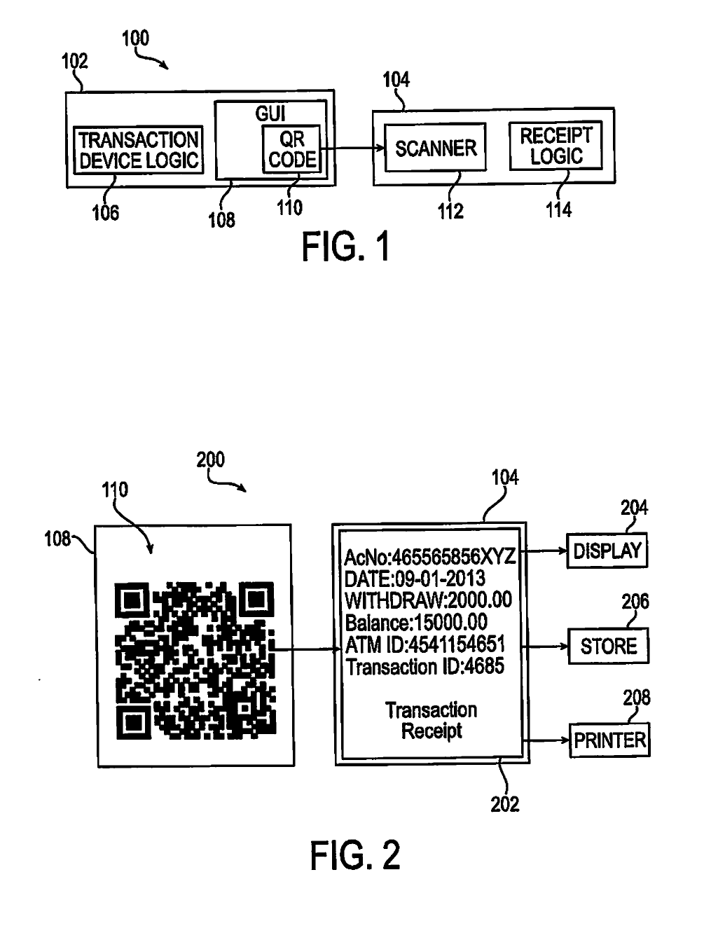

FIG. 1 is a block diagram 100 illustrating an example of a Quick Response (QR) code being employed as a transaction receipt. A transaction device 102, such as an automated teller machine (ATM) and/or a point of sale (POS) device, comprises transaction device logic 106 for obtaining data representative of a transaction. “Logic”, as used herein, includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (ASIC), a programmable/programmed logic device, memory device containing instructions, or the like, or combinational logic embodied in hardware. Logic may also be fully implemented in software embodied on a non-transitory computer-readable medium that performs the described functionality when executed by processor. For example, for an automated banking machine such as an ATM the data representative of a transaction may suitably comprise a deposit (e.g., a check or cash deposit), a withdrawal (e.g., a cash withdrawal or a check request), a balance inquiry, and/or any other suitable type of transaction from a financial account, and data identifying the financial account. For a POS, the data representative of a transaction may include a description of goods and/or services purchased an amount and type (e.g., cash, check, and/or credit card) of payment.

The transaction device 102 further comprises a graphical user interface (GUI) such as a display. In particular embodiments, the GUI may further include a touch screen interface. The transaction device logic 106 is operable to generate a quick response (QR) code 110 that comprises the data representative of the transaction, The transaction device logic 106 is further operable to cause the QR code 110 to be displayed on the GUI 108.

In an example embodiment, the transaction device logic 106 obtains data representative of a plurality of transactions. For example, a consumer may make multiple deposits, withdrawals, and/or a combination of deposits and withdrawals at an ATM, or may purchase multiple goods and/or services and/or provide multiple payment methods (e.g., cash and a credit card account for the remaining balance). The transaction device logic 106 creates a QR code 110 that comprises data representative of the plurality of transactions.

A scanning device 104 is operable to obtain the QR code 110 from the transaction device 102 and create a receipt (not shown, see, e.g., receipt 202 in FIG. 2) from the QR code. The scanning device 104 comprises a scanner 112 that can scan or read the QR code 110 and receipt logic 114 that can create the receipt from the scanned QR code.

In an example embodiment, the QR code 110 may displayed for a predetermined amount of time and/or until the transaction device logic 106 receives an indication that the scanning device 112 scanned the device. For example, an input may be received from a consumer (user) via GUI 108 to indicate the QR code 110 was scanned. As another example, scanning device 104 may send a signal to the transaction device 102 responsive to receipt logic 114 determining that the scanner 112 obtained a scan of the QR code 110.

In an example embodiment, an option may be employed to allow a consumer select whether to receive a QR code receipt, a paper receipt, or both. The transaction device logic 106 may cause a paper receipt to be created responsive to receiving an input from the user requesting a paper receipt.

In an example embodiment, the transaction device logic 106 is further operable encrypt the data representative of the transaction. The transaction device logic 106 generates the QR code 110 with the encrypted data representative of the transaction. In particular embodiments, the receipt logic 114 is operable to decrypt the data representative of the transaction from the QR code 110.

In an example embodiment, the receipt logic 114 is operable to store the receipt created from the QR code. In particular embodiments, the receipt logic 114 may be operable to provide options to enable a user to print the receipt and/or forward the receipt (e.g., via an email message, SMS (short message service), and/or MMS (multimedia messaging service).

An aspect of an example embodiment is that by not printing paper receipts cost savings may be realized. The cost of the paper and ink are saved by not printing a paper receipt. Moreover, the area around an ATM and/or POS device may be cleaner because consumers won't be discarding unwanted paper receipts.

FIG. 2 is a block diagram 200 illustrating an example of the QR code 110 being translated into a receipt 202 and subsequent forwarding. In the illustrated example, the receipt 202 can be forwarded to a display 204, a data store 206, and/or a printer 208 by receipt logic 114 (FIG. 1).

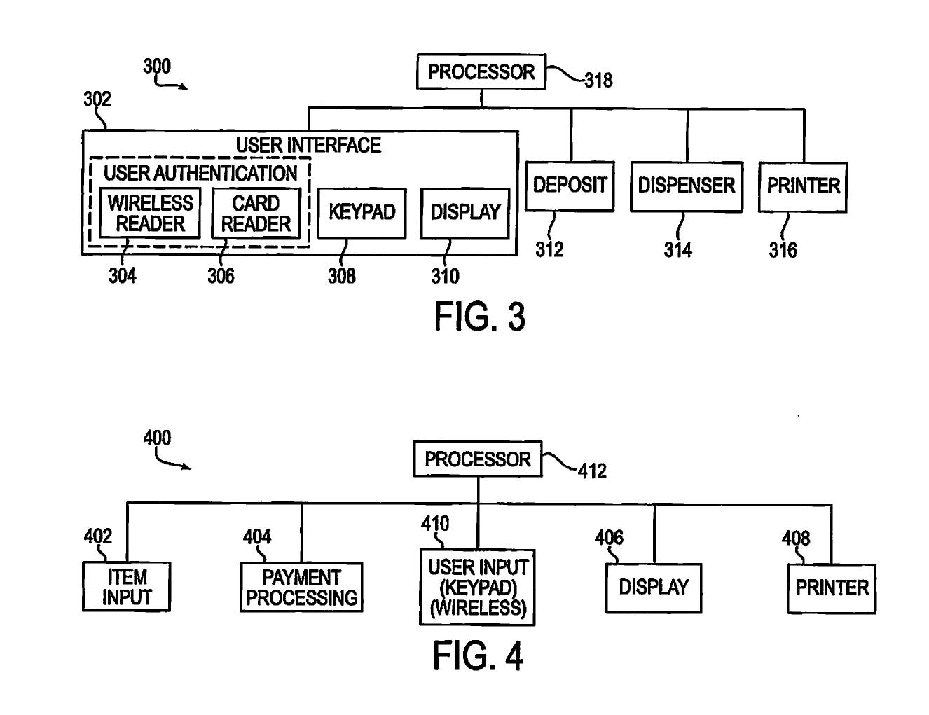

FIG. 3 is a functional block diagram illustrating an example of an automated banking machine 300 that provides a QR code for a transaction receipt. Note that the components listed herein are for illustrative purposes only and those skilled in the art should readily appreciate that some example embodiments may not include all of the illustrated components. Those skilled in the art should also readily appreciate that this diagram is functional, and that some components may be combined (e.g., the keypad and display may be combined into a touch screen display). The automated banking machine comprises a user interface module 302. In the illustrated example, the user interface module 302 comprises user authentication devices such as a wireless reader 304 and a card reader 306. The user interface module 302 may further include a keypad 308 and a display 310. In particular embodiments, the keypad 308 and display 310 are integrated together in a touch screen.

The automated banking machine 300 further comprises transaction function devices. The transaction function devices include, but are not limited to, a deposit device 312, a dispenser device 314, a printer 316, and a processor 318.

In an example embodiment, the deposit device 312 is suitable for accepting paper deposits, such as cash or checks. The dispenser device 314 may dispense cash or other documents, such as checks, coupons, marketing materials, etc. In particular embodiments, a deposit device 312 and dispenser device 314 are coupled together to form a cash recycle (for example, the deposit device 312 can receive cash while the dispenser device 314 can dispense cash that was received via the deposit device 312.

The printer 316 is suitable for printing receipts. In accordance with an example embodiment, a consumer may elect to receive a receipt via a QR code output on the display 310 instead of receiving a receipt from printer 316.

The processor 318 is coupled with the user interface 302 (as well as the wireless reader 304, card reader 306, keypad 308, and display 310), deposit device 312, dispenser device 314, and printer 316. The processor 318 implements the functionality described herein.

In an example embodiment, a consumer employs the user interface 302 to perform financial transactions involving a financial account. In particular embodiments, multiple transactions and/or multiple accounts may be employed in the transaction. Account data may be obtained from a card inserted, or swiped, into card reader 306 and/or from data received via wireless reader 304. For example, account and/or transaction data may be obtained by wireless reader 304 from a smart phone associated with the consumer. In particular embodiments, the consumer may employ the keypad 308 for inputting personal identification number (PIN) data. The consumer may make a deposit employing deposit device 312, and/or a withdrawal employing dispenser 312. In particular embodiments, the consumer may make a balance inquiry of a financial account.

In an example embodiment, the processor 318 is operable to perform transactions based on data obtained from users (consumers) via the user interface module 304. The processor 318 is operable to output an option on display 310 for users to request a printed receipt or a quick response (QR) code receipt for a transaction. The processor 318 is operable to obtain an input, for example via keypad 308, or a user may make a selection on a wireless device that is transmitted to wireless reader 304, from a user indicating a selection of either a printed receipt or a QR receipt. The processor 318 is operable to selectively print a receipt employing printer 316 for a transaction to a user requesting a printed receipt. The processor 318 is operable to selectively display a on the display 310 a QR code receipt for a transaction to a user requesting a QR receipt.

FIG. 4 is a functional block diagram illustrating an example of a point of sale (POS) device 400 that provides a QR code for a transaction receipt. Note that the components listed herein are for illustrative purposes only and those skilled in the art should readily appreciate that some example embodiments may not include all of the illustrated components. Those skilled in the art should also readily appreciate that some components may be combined (e.g., display 406 user input device 410 may be combined into a touch screen display.

The illustrated example comprises an item input device 402 for receiving data representative of goods and/or services being purchased. Some examples of an item input device 402 include, but are not limited to, a touch screen, a keypad and display, a communications interface that can receive data from a remote computer (for example if the user is making a purchase via a web page), and/or a scanner. In particular embodiments, the input device 402 may include multiple input devices.

The payment processing device 404 can be any suitable device for accepting payment for the goods and/or services purchased. Examples of payment processing devices include, but are not limited to, credit card readers, cash handlers, and/or a computer interface that may receive payment data from a remote computer.

The display 406 may be any suitable device that provides a visual output. The display 406 may also include an audio device for sight impaired consumers. In some embodiments, the display 406 may be a touch screen. The printer 408 can be employed for printing paper receipts for a transaction.

In an example embodiment, goods and/or services are obtained by processor 412 via item input device 402. The processor 412 calculates an amount due which can be output on display 406. The consumer employs payment processing device 404 for presenting payment.

In an example embodiment, the user can employ a user input device 410, such as a keypad and/or a wireless interface coupled with a wireless device associated with the user to select whether to receive a paper receipt, a QR code receipt, or both. Based on the user input received by user input device 410, the processor 412 selectively outputs a QR code on display 406 and/or a prints a receipt

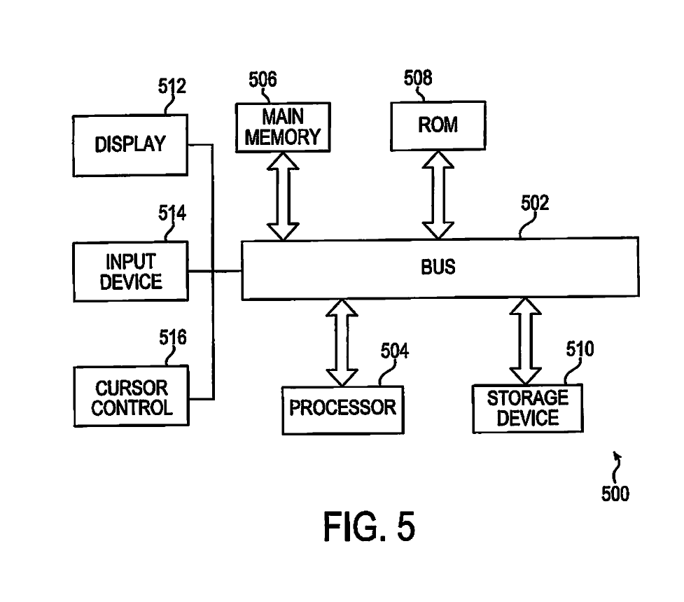

FIG. 5 is a block diagram illustrating an example of a computer system 500 that can provide a QR code for a transaction receipt and/or create a receipt from a QR code. Computer system 500 may be employed transaction device logic 106 (FIG. 1), receipt logic 114 (FIG. 1), processor 318 (FIG. 3), and/or processor 410 (FIG. 4).

Computer system 500 includes a bus 502 or other communication mechanism for communicating information and a processor 504 coupled with bus 502 for processing information. Computer system 500 also includes a main memory 506, such as random access memory (RAM) or other dynamic storage device coupled to bus 502 for storing information and instructions to be executed by processor 504. Main memory 506 also may be used for storing a temporary variable or other intermediate information during execution of instructions to be executed by processor 504. Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512 such as a cathode ray tube (CRT) or liquid crystal display (LCD), for displaying information to a computer user. An input device 514, such as a keyboard including alphanumeric and other keys is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g. x) and a second axis (e.g. y) that allows the device to specify positions in a plane.

An aspect of the example embodiment is related to the use of computer system 500 for QR code receipts. According to an example embodiment, a QR code receipt is provided by computer system 500 in response to processor 504 executing one or more sequences of one or more instructions contained in main memory 506. Such instructions may be read into main memory 506 from another computer-readable medium, such as storage device 510. Execution of the sequence of instructions contained in main memory 506 causes processor 504 to perform the process steps described herein. One or more processors in a multi-processing arrangement may also be employed to execute the sequences of instructions contained in main memory 506. In alternative embodiments, hard-wired circuitry may be used in place of or in combination with software instructions to implement an example embodiment. Thus, embodiments described herein are not limited to any specific combination of hardware circuitry and software.

The term “computer-readable medium” as used herein refers to any medium that participates in providing instructions to processor 504 for execution. Such a medium may take many forms, including but not limited to non-volatile media, volatile media, and transmission media. Non-volatile media include for example optical or magnetic disks, such as storage device 510. Volatile media include dynamic memory such as main memory 506. Transmission media include coaxial cables, copper wire and fiber optics, including the wires that comprise bus 502. Transmission media can also take the form of acoustic or light waves such as those generated during radio frequency (RF) and infrared (IR) data communications. Common forms of computer-readable media include for example floppy disk, a flexible disk, hard disk, magnetic cards, paper tape, any other physical medium with patterns of holes, a RAM, a PROM, an EPROM, a FLASHPROM, CD, DVD or any other memory chip or cartridge, or any other medium from which a computer can read.

In an example embodiment, the processor 504 is operable to obtain data representative of a transaction. The processor 504 creates a QR code with data representative of the transaction. The processor causes the QR code to be displayed on display 512.

In an example embodiment, the processor 504 is operable to obtain a QR code. For example, the processor 504 may obtain a CR code from a scanner (not shown, see e.g., scanner 112 described in FIG. 1) that is coupled with bus 502 (for example via an interface). The processor 504 is operable to create an image corresponding to the receipt in human readable form (see e.g., receipt 202 in FIG. 2). The image can be displayed on display 512, stored in storage device 510, and/or printed via a printer coupled with bus 502 (not shown, see e.g., printer 208 in FIG. 2).

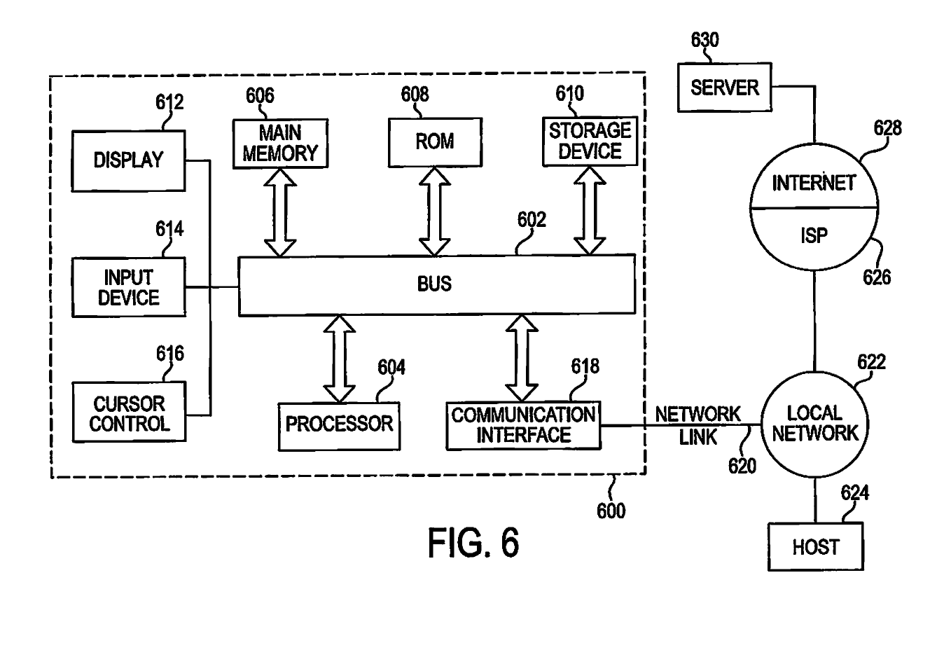

FIG. 6 is a block diagram illustrating an example of a computer system 600 coupled with a network that can provide a QR code for a transaction receipt. Computer system 600 may be employed to implement the functionality of transaction device logic 106 (FIG. 1), processor 318 (FIG. 3) and/or processor 410 (FIG. 4).

Computer system 600 includes a bus 602 or other communication mechanism for communicating information and a processor 604 coupled with bus 602 for processing information. Computer system 600 also includes a main memory 606, such as random access memory (RAM) or other dynamic storage device coupled to bus 602 for storing information and instructions to be executed by processor 604. Main memory 606 also may be used for storing a temporary variable or other intermediate information during execution of instructions to be executed by processor 604. Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612 such as a cathode ray tube (CRT) or liquid crystal display (LCD), for displaying information to a computer user. An input device 614, such as a keyboard including alphanumeric and other keys is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g. x) and a second axis (e.g. y) that allows the device to specify positions in a plane.

Optionally, a printer (not shown, see e.g., printer 316 in FIG. 3) or printer 408 in FIG. 4) is coupled with computer system 600. The printer may be coupled with bus 602 via any suitable type of interface.

An aspect of the example embodiment is related to the use of computer system 600 for creating QR codes for transaction receipts. According to an example embodiment, creating QR codes for transaction receipts is provided by computer system 600 in response to processor 604 executing one or more sequences of one or more instructions contained in main memory 606. Such instructions may be read into main memory 606 from another computer-readable medium, such as storage device 610. Execution of the sequence of instructions contained in main memory 606 causes processor 604 to perform the process steps described herein. One or more processors in a multi-processing arrangement may also be employed to execute the sequences of instructions contained in main memory 606. In alternative embodiments, hard-wired circuitry may be used in place of or in combination with software instructions to implement an example embodiment. Thus, embodiments described herein are not limited to any specific combination of hardware circuitry and software.

Computer system 600 also includes a communication interface 618 coupled to bus 602. Communication interface 618 provides a two-way data communication coupling computer system 600 to a network link 620 that is connected to a local network 622. For example, communication interface 618 may be a local area network (LAN) card to provide a data communication connection to a compatible LAN. As another example, communication interface 618 may be an integrated services digital network (ISDN) card or a modem to provide a data communication connection to a corresponding type of telephone line. Wireless links may also be implemented. In any such implementation, communication interface 618 sends and receives electrical, electromagnetic, or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communications through the worldwide packet data communication network, now commonly referred to as the “Internet” 628.

In an example embodiment, the processor 604 is operable to obtain data representative of a transaction. The processor 604 creates a QR code with data representative of the transaction. The processor causes the QR code to be displayed on display 612.

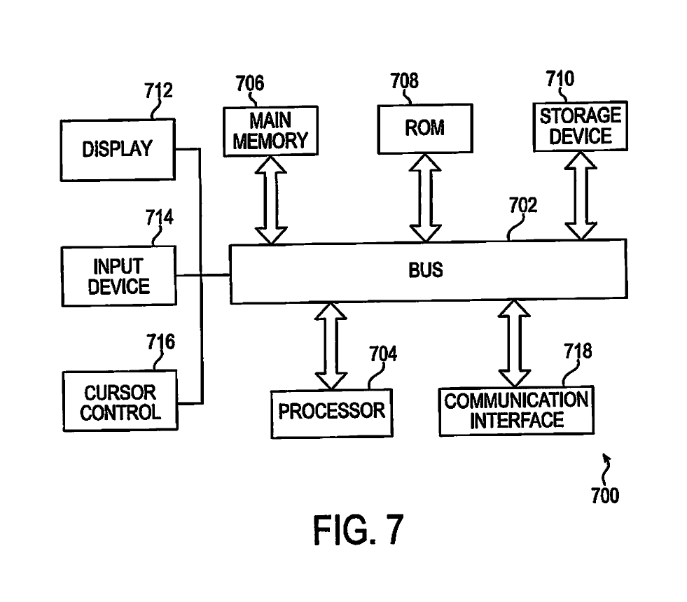

FIG. 7 is a block diagram illustrating an example of a computer system that can obtain a QR code for a transaction receipt. For example, computer system 700 can be employed to implement the functionality of receipt logic 114 described in FIG. 1.

Computer system 700 includes a bus 702 or other communication mechanism for communicating information and a processor 704 coupled with bus 702 for processing information. Computer system 700 also includes a main memory 706, such as random access memory (RAM) or other dynamic storage device coupled to bus 702 for storing information and instructions to be executed by processor 704. Main memory 706 also may be used for storing a temporary variable or other intermediate information during execution of instructions to be executed by processor 704. Computer system 700 further includes a read only memory (ROM) 708 or other static storage device coupled to bus 702 for storing static information and instructions for processor 704. A storage device 710, such as a magnetic disk or optical disk, is provided and coupled to bus 702 for storing information and instructions.

Computer system 700 may be coupled via bus 702 to a display 712 such as a cathode ray tube (CRT) or liquid crystal display (LCD), for displaying information to a computer user. An input device 714, such as a keyboard including alphanumeric and other keys is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g. x) and a second axis (e.g. y) that allows the device to specify positions in a plane.

An aspect of the example embodiment is related to the use of computer system 700 for obtaining QR code for a transaction receipt and creating an image corresponding to the receipt for the transaction from the QR code. According to an example embodiment, obtaining QR code for a transaction receipt and creating an image corresponding to the receipt for the transaction from the QR code is provided by computer system 700 in response to processor 704 executing one or more sequences of one or more instructions contained in main memory 706. Such instructions may be read into main memory 706 from another computer-readable medium, such as storage device 710. Execution of the sequence of instructions contained in main memory 706 causes processor 704 to perform the process steps described herein. One or more processors in a multi-processing arrangement may also be employed to execute the sequences of instructions contained in main memory 706. In alternative embodiments, hard-wired circuitry may be used in place of or in combination with software instructions to implement an example embodiment. Thus, embodiments described herein are not limited to any specific combination of hardware circuitry and software.

Computer system 700 also includes a communication interface 718 coupled to bus 702. Communication interface 718 provides a two-way data communication coupling computer system 700 to a network link 720 that is connected to a local network 722. For example, communication interface may be employed by processor 704 to exchange signals with a transaction device, such as transaction device 102 in FIG. 1, to perform the transaction and/or to signal the transaction device that the QR code has been scanned. In smart phone embodiments, the communication interface 718 may be employed to communicate with a cellular network. In particular embodiments, multiple communication interfaces 718 may beg employed. For example, one communication interface may be employed for communicating with a cellular network while another communication interface may use another communication protocol, such as near field communication (NFC) to communicate with the transaction device.

In an example embodiment, the processor 704 is operable to obtain a QR code. For example, the processor 704 may obtain a CR code from a scanner (not shown, see e.g., scanner 112 described in FIG. 1) that is coupled with bus 502 (for example via an interface). The processor 704 is operable to create an image corresponding to the receipt in human readable form (see e.g., receipt 202 in FIG. 2). The image can be displayed on display 712, stored in storage device 510, and/or printed via a printer coupled with bus 702 (not shown, see e.g., printer 208 in FIG. 2).

In view of the foregoing structural and functional features described above, a methodologies in accordance with an example embodiment will be better appreciated with reference to FIGS. 7-10. While for purposes of simplicity of explanation, the methodologies of FIGS. 7-10 are shown and described as executing serially, it is to be understood and appreciated that the example embodiments are not limited by the illustrated orders, as some aspects could occur in different orders and/or concurrently with other aspects from that shown and described herein. Moreover, not all illustrated features may be required. The methodologies described herein is suitably adapted to be implemented in hardware, software when executed by a processor, or a combination thereof.

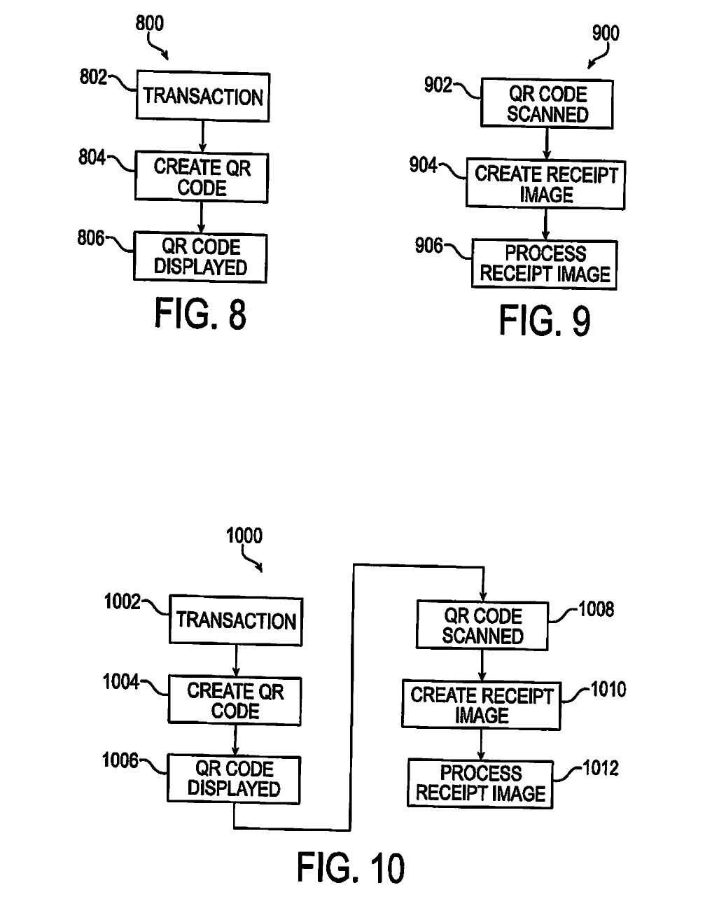

FIG. 8 is a block diagram illustrating a methodology 800 that creates a QR code for a transaction receipt. Methodology 800 can be implemented by transaction device logic 106 (FIG. 1), processor 318 (FIG. 3), processor 410 (FIG. 4), processor 504 (FIG. 5), and/or processor 604 (FIG. 6).

At 802, a transaction is performed. The transaction may involve an automated banking machine, such as an ATM or a point of sale (POS) device. For example, an ATM may be employed to make a deposit (e.g., a check or cash), a withdrawal (e.g., cash, check, or other financial document), and/or a balance inquiry involving a financial account. As another example, a POS device may be employed to purchase goods or services. The device performing the transaction obtains data representative of the transaction. For example, an ATM may have data representative of an amount of a deposit and/or withdrawal, an account number, and/or an account balance. In some embodiments, the data obtained by the ATM may include have an image of the item being deposited (for example an image of a check that was deposited a the ATM). A POS device may obtain data representative of a description of a good and/or service being purchased, a method, or methods, of payment, etc. In particular embodiments, a plurality of transactions may be performed.

At 804, a QR code is created. The QR code is based on the data representative of the transaction, or data representative of a plurality of transactions. Any physically realizable number of transactions can be represented by a QR code. In particular embodiments, the data representative of the transaction is encrypted.

At 806, the QR code is displayed. The QR code may be displayed on any suitable visual output device. In an example embodiment, the QR code is displayed for a predetermined amount of time and/or until an input is obtained indicating the QR code was scanned. In another example embodiment, the QR code is displayed after a user input (such as pressing a predefined key, or in some embodiments any key, before displaying the QR code. Optionally, in particular embodiments a printed receipt (for example in a human readable format and not in QR code format) may also be provided.

FIG. 9 is a block diagram illustrating a methodology 900 that reads a QR code and creates a transaction receipt from the QR code. Methodology 900 can be implemented by receipt logic 114 (FIG. 1) and/or processor 704 (FIG. 7).

At 902, the QR code is scanned by a scanning device. Any suitable device that can obtain an optical image can be employed. For example, a Smartphone with a scanner and a QR code application may be employed. In particular embodiments, a signal may be sent to the source of the QR code (e.g., the ATM or POS device providing the QR code image) to indicate that the QR code was scanned.

At 904, an image of the receipt is created from the QR code. In particular embodiments, if the transaction data was encrypted, the transaction data is encrypted to generate the receipt. An example of a receipt created from a QR code is provided in FIG. 2. The receipt may include, but is not limited to transaction type (e.g., deposit, withdrawal, balance inquiry, purchase of goods and/or services, etc.) amount of transaction, financial accounts associated with the transaction (e.g., account for a deposit or withdrawal , account for paying for a purchase of goods and/or services, etc.), account balance, identification of ATM or POS, date, time, etc.

At 906, the receipt image is processed. For example, the receipt image may be displayed on a visual display device. As another example, the receipt image may be stored in a data store. As yet, another example the receipt image may be printed. Other embodiments may include a combination of displaying, storing, and/or printing the receipt. Storing the receipt may further include sending the receipt image to another device. For example, the receipt image may be emailed, and/or sent via SMS, and/or MMS.

FIG. 10 is a block diagram illustrating a methodology 1000 that provides a QR code as a transaction receipt. The QR code may be scanned and a transaction receipt is created from the QR code. For example, actions 1002, 1004, and 1006 may be performed by transaction device logic 106 (FIG. 1), processor 318 (FIG. 3), processor 410 (FIG. 4), processor 504 (FIG. 5), and/or processor 604 (FIG. 6), and actions 1008, 1010, and 1012 may be performed by receipt logic 114 (FIG. 1) and/or processor 704 (FIG. 7).

At 1002, a transaction is performed. The transaction may involve an automated banking machine, such as an ATM or a point of sale (POS) device. For example, an ATM may be employed to make a deposit (e.g., a check or cash), a withdrawal (e.g., cash, check, or other financial document), and/or a balance inquiry involving a financial account. As another example, a POS device may be employed to purchase goods or services. The device performing the transaction obtains data representative of the transaction. For example, an ATM may have data representative of an amount of a deposit and/or withdrawal, an account number, and/or an account balance. In some embodiments, the data obtained by the ATM may include have an image of the item being deposited (for example an image of a check that was deposited a the ATM). A POS device may obtain data representative of a description of a good and/or service being purchased, a method, or methods, of payment, etc. In particular embodiments, a plurality of transactions may be performed.

At 1004, a QR code is created. The QR code is based on the data representative of the transaction, or data representative of a plurality of transactions. Any physically realizable number of transactions can be represented by a QR code. In particular embodiments, the data representative of the transaction is encrypted.

At 1006, the QR code is displayed. The QR code may be displayed on any suitable visual output device. In an example embodiment, the QR code is displayed for a predetermined amount of time and/or until an input is obtained indicating the QR code was scanned. In another example embodiment, the QR code is displayed after a user input (such as pressing a predefined key, or in some embodiments any key, before displaying the QR code. Optionally, in particular embodiments a printed receipt (for example in a human readable format and not in QR code format) may also be provided.

At 1008, the QR code is scanned by a scanning device. Any suitable device that can obtain an optical image can be employed. For example, a Smartphone with a scanner and a QR code application may be employed. In particular embodiments, a signal may be sent to the source of the QR code (e.g., the ATM or POS device providing the QR code image) to indicate that the QR code was scanned.

At 1010, an image of the receipt is created from the QR code. In particular embodiments, if the transaction data was encrypted, the transaction data is encrypted to generate the receipt. An example of a receipt created from a QR code is provided in FIG. 2. The receipt may include, but is not limited to transaction type (e.g., deposit, withdrawal, balance inquiry, purchase of goods and/or services, etc.) amount of transaction, financial accounts associated with the transaction (e.g., account for a deposit or withdrawal , account for paying for a purchase of goods and/or services, etc.), account balance, identification of ATM or POS, date, time, etc.

At 1012, the receipt image is processed. For example, the receipt image may be displayed on a visual display device. As another example, the receipt image may be stored in a data store. As yet, another example the receipt image may be printed. Other embodiments may include a combination of displaying, storing, and/or printing the receipt. Storing the receipt may further include sending the receipt image to another device. For example, the receipt image may be emailed, and/or sent via SMS, and/or MMS.

Described above are example embodiments. It is, of course, not possible to describe every conceivable combination of components or methodologies, but one of ordinary skill in the art will recognize that many further combinations and permutations of the example embodiments are possible. Accordingly, this application is intended to embrace all such alterations, modifications and variations that fall within the spirit and scope of the appended claims interpreted in accordance with the breadth to which they are fairly, legally and equitably entitled.

1. Logic encoded in a tangible, non-transitory computer readable medium for execution, and when executed operable to:
perform transactions based on data obtained from users via a user interface module. that comprises a display and an input;
cause the display to output an option for users to request one of a group consisting of a printed receipt a quick response (QR) code receipt, and both a printed receipt and a QR code for a transaction;
obtain a selection via the input from users indicating a selection of one of the group consisting of a printed receipt a quick response (QR) code receipt, and both a printed receipt and a QR code for a transaction;
wherein the processor is operable to selectively print a receipt for a transaction to users selecting a printed receipt;
wherein the processor is operable to selectively display a QR code for a transaction on the display to users selecting a QR code receipt, wherein the QR code comprises data representative of the transaction; and
wherein the processor is operable to selectively both print a receipt and display a QR code to users selecting both a receipt and a QR code.

2. The logic set forth in claim 1, further operable to encrypt the data representative of the transaction.

3. The logic set forth in claim 2, further operable to generate the QR code with the encrypted data representative of the transaction.

4. The logic set forth in claim 1, wherein the QR code comprises data representative of a plurality of transactions.

5. The logic set forth in claim 1, wherein the transaction is a deposit.

6. The logic set forth in claim 1, wherein the transaction is a cash withdrawal.

7. The logic set forth in claim 1, wherein the transaction is a balance inquiry; and
the data representative of a transaction comprises account balance data.

8. The logic set forth in claim 1, wherein the transaction is a payment for a good, a service, or a combination of a good and service.

9. The logic set forth in claim 1, further operable to obtain data indicating the QR code was read by a device associated with a user associated with the transaction.

10. The logic set forth in claim 1, wherein the QR code is displayed for a predetermined time period.

11. The logic set forth in claim 1, wherein the data representative of the transaction comprises an amount of the transaction.

12. The logic set forth in claim 1, wherein the data representative of the transaction comprises an account associated with the transaction.

13. The logic set forth in claim 1, further comprising providing an option on a user interface for selectively providing a paper receipt; and
cause a paper receipt to be created responsive to receiving an input from the user requesting a paper receipt.

14. An apparatus, comprising:
a user interface module that comprises a display and an input;
a printer; and
a processor coupled with the user interface module, and the printer;
wherein the processor is operable to perform transactions based on data obtained from users via the user interface module;
wherein the processor is operable to output on the display an option for users to request one of a group consisting of a printed receipt a quick response (QR) code receipt, and both a printed receipt and a QR code for a transaction;
wherein the processor is operable to obtain a user selections via the input from users indicating a selection of one of the group consisting of a printed receipt a quick response (QR) code receipt, and both a printed receipt and a QR code for a transaction;
wherein the processor is operable to selectively print a receipt for a transaction to users selecting a printed receipt;
wherein the processor is operable to selectively display a QR code for a transaction on the display to users selecting a QR code receipt, wherein the QR code comprises data representative of the transaction; and
wherein the processor is operable to selectively both print a receipt and display a QR code to users selecting both a receipt and a QR code.

15-20. (canceled)

21. The apparatus set forth in claim 14, the processor is further operable to encrypt the data representative of the transaction.

22. The apparatus set forth in claim 21, the processor is further operable to generate the QR code with the encrypted data representative of the transaction.

23. The apparatus set forth in claim 14, wherein the QR code comprises data representative of a plurality of transactions.

24. The apparatus set forth in claim 14, wherein the transaction is a deposit.

25. The apparatus set forth in claim 14, wherein the transaction is a cash withdrawal.

26. The apparatus set forth in claim 14, wherein the transaction is a balance inquiry; and
the data representative of a transaction comprises account balance data.
